(19) United States
(12) Patent Application Publication
(10) Pub. No.: US 2016/0202405 A1
(43) Pub. Date: Jul. 14, 2016

(54) POLARIZATION FILTER HAVING METALLIC WEBS

(71) Applicant: FRAUNHOFER-GESELLSCHAFT ZUR FOERDERUNG DER ANGEWANDTEN FORSCHUNG E.V., Muenchen (DE)

(72) Inventors: NORBERT WEBER, Weissenohe (DE); STEPHAN JUNGER, Bubenreuth (DE); HARALD NEUBAUER, Erlangen (DE)

(21) Appl. No.: 14/993,313

(22) Filed: Jan. 12, 2016

(30) Foreign Application Priority Data
Jan. 13, 2015 (DE) 10 2015 200 324.8

(51) Int. Cl. G02B 5/30; G01J 4/04

(52) U.S. Cl. CPC G02B 5/3058; G02B 5/3075; G01J 4/04

(57) ABSTRACT

The present invention relates to a polarization filter which is formed by at least one periodic line grid made from parallel extending metallic webs on a dielectric layer. The metallic webs are interrupted in their longitudinal extension by slots. The centre-to-centre distances between the slots are greater than the period of the line grid in a direction parallel to the metallic webs. The proposed polarization filter can be produced with a CMOS process with high reliability, in particular for the visible spectral range, even over a larger area.

### TECHNICAL FIELD OF APPLICATION

The present invention relates to a polarization filter, in particular for the visible or ultraviolet spectral range, which is formed by at least one periodic line grid made from parallel extending metallic webs on a dielectric layer. The invention also relates to a polarization sensor that is equipped with such a polarization filter.

Polarization filters with periodic line grid made from parallel extending metal webs are known mainly in the infra-red and even longer-wavelength spectral ranges. The period of the line grid must be less than the wavelength, or wavelength range, for which the polarization filter is designed. This leads to problems in the production of the line grid if the polarization filter is intended to be used with visible light. The period of the sequence of metallic webs forming the grid and the intervening spaces must then be in the range ≦300 nm. At the same time however, the metal webs must be relatively large (e.g. approximately 400 nm), in order to obtain a high contrast ratio of the polarization filter. With dimensions such as these however, the production of such a filter over a larger area, of e.g. more than 3×3 μm², in a CMOS process results in a low yield, since some of the elongated webs of the grid collapse during the etching process. Reliable processing cannot therefore be obtained with high process yield.

Document U.S. Pat. No. 7,186,968 B2 shows an example of such a polarization filter, in which the grid period is 320 nm. The individual grid webs have a width of 160 nm. If such a polarization filter with a high contrast ratio is intended to be produced in a CMOS process, then a high processing reliability cannot normally be expected. Some of the webs of the grid will not remain stationary, but will tilt to one side, and the intended function as a polarization filter will be partially or completely lost. The document gives no indication as to how this issue can be addressed.

The object of the present invention is to specify a polarization filter with a line grid made from parallel extending metallic webs, which can also be produced for the visible spectral range in a CMOS process with high reliability.

### DESCRIPTION OF THE INVENTION

The object is achieved with the polarization filter in accordance with Claim 1. Advantageous configurations of the polarization filter are the subject matter of the dependent claims or can be inferred from the following description together with the exemplary embodiments. Claim 7 specifies a polarization sensor which comprises a polarizing filter designed according to the invention.

The proposed polarization filter is formed in a known manner by at least one periodic line grid made from parallel extending metallic webs on a dielectric layer. The period of the line grid, also designated the pitch, is selected so that it is smaller than the wavelengths of the wavelength range for which the polarization filter is designed. The period or the pitch is understood in the known manner to mean the sum of the widths of one metallic web and one space between the metallic webs. The dielectric layer on which the metallic webs are arranged must be either transparent or reflective for the relevant wavelength range. The proposed polarization filter is characterized in that the metallic webs are interrupted by slots in their longitudinal extension. Each of the slots extends over the full width of the webs. The centre-to-centre distances between these slots are larger than the period of the line grid or the centre-to-centre distances of the metal webs in the direction perpendicular thereto. The slots can have any cross-sectional shape in the plane of the longitudinal axis of the metallic webs perpendicular to the dielectric layer, for example a rectangular, V-shaped, or U-shaped cross section.

The presence of these slots in the metal webs means that the high aspect ratio of the webs occurs only in each of the shorter sections extending between the slots. Shorter web sections have a higher stability than longer web sections. In the case of webs with a high aspect ratio, this also prevents the webs from tilting or from collapsing during manufacture. By appropriate selection of the centre-to-centre distances of the slots to be greater than the pitch of the metallic webs, the polarization effect is not adversely affected. The depth of the slots preferably extends down to the dielectric layer, i.e. the depth of the slots is equal to the height of the metallic webs. The depth of the slots can however also have a value that is smaller by comparison.

The proposed polarization filter can be very advantageously produced in a CMOS process in which a metallic layer is first applied to the dielectric layer to a thickness equal to the desired height of the metallic webs. This metallic layer is then structured in a lithography process in such a manner that the desired metallic webs are formed with the slots extending perpendicular to their longitudinal extension. This can be carried out using known etching processes.

Due to the proposed structure of the polarization filter, such a filter can also be produced with high aspect ratio with high reliability on a larger area for both the visible and for the ultraviolet spectral range, because due to the slots the metallic webs can no longer tilt to one side or collapse during production. The slots are arranged as required and can be implemented either in a regular sequence, i.e. each having the same centre-to-centre distance, or also in an irregular arrangement with varying centre-to-centre distances.

The slots extend at an angle to the metallic webs of the line grid. A particularly advantageous arrangement is one in which the slots extend perpendicularly to the metallic webs of the line grid. This arrangement achieves the highest stability. The slots can also be implemented so that they are wider or narrower than the metallic webs of the line grid. They can have any geometrical shape, being implemented for example with cross sections (parallel to the dielectric layer) in the form of diamonds, triangles, circular discs or circular cutouts, as long as they enable the desired interruption of the metallic webs.

In order to achieve an adequate contrast of the polarization filter, the aspect ratio of the metallic grid webs should be sufficiently large, the height of the metallic webs being preferably larger than their width. Thus for the visible spectral range, for example, a height of approximately 400 nm can be selected at a width of ≦300 nm.

In a preferred configuration the proposed polarization filter is used in a polarization sensor. A polarization sensor in CMOS technology generally comprises a photo-sensitive element such as a photodiode, above which the polarization filter, separated by one or more dielectric layers, is located. In the present case, a polarization sensor with the proposed polarization filter can be implemented in CMOS technology for the visible or ultraviolet spectral range.

The proposed polarization filter can naturally also be used independently, wherein the dielectric layer is then applied either directly or via one or more intermediate layers onto a carrier substrate, or forms a carrier substrate itself. In this case a plurality of line grids with identical or different configurations can also be applied next to each other on the carrier substrate. This also applies in the same way to a configuration in a polarization sensor, in which the area above the photo-sensitive element can then be completely covered with corresponding line grids.

In comparison to polarization filters of generic type from the prior art, the proposed polarization filter allows production with significantly smaller spacing of the grid lines and/or with a larger area at high yield. This allows the lower usable wavelength of the polarization filter to be reduced so that the filter can also be dimensioned for wavelengths at the lower limit of the visible spectrum and down into the ultraviolet spectral range. If the structure of the proposed polarization filter is used to enlarge the filter surface area, then polarisation sensors can be implemented that are much larger than conventional pixel sizes of image sensors. Large-area polarization sensors with an edge length of several hundred μm can also be produced in this way. This enables the light-sensitive area to be enlarged and the sensitivity of the sensor to be increased. Such polarization sensors can be used, for example, in polarization cameras or in rotary encoders.

### BRIEF DESCRIPTION OF THE DRAWINGS

The proposed polarization filter is explained once again in more detail hereafter, on the basis of exemplary embodiments in conjunction with the drawings. They show:

FIG. 1 a first example of a structure of the proposed polarization filter in plan view (a) and in cross section (b);

FIG. 2 a second example of a structure of the proposed polarization filter in plan view; and

FIG. 3 a third example of a structure of the proposed polarization filter in plan view.

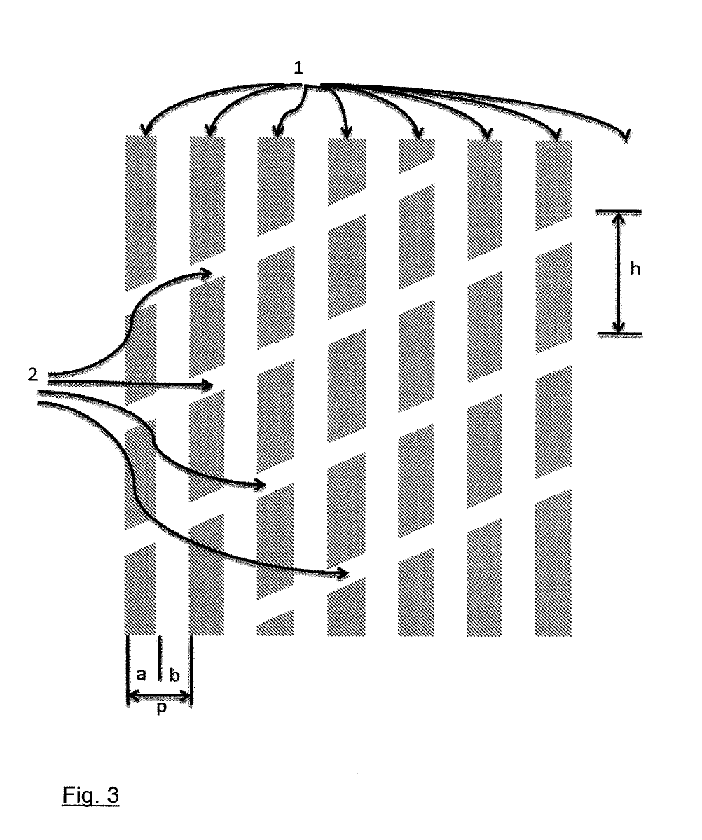

### WAYS OF EMBODYING THE INVENTION

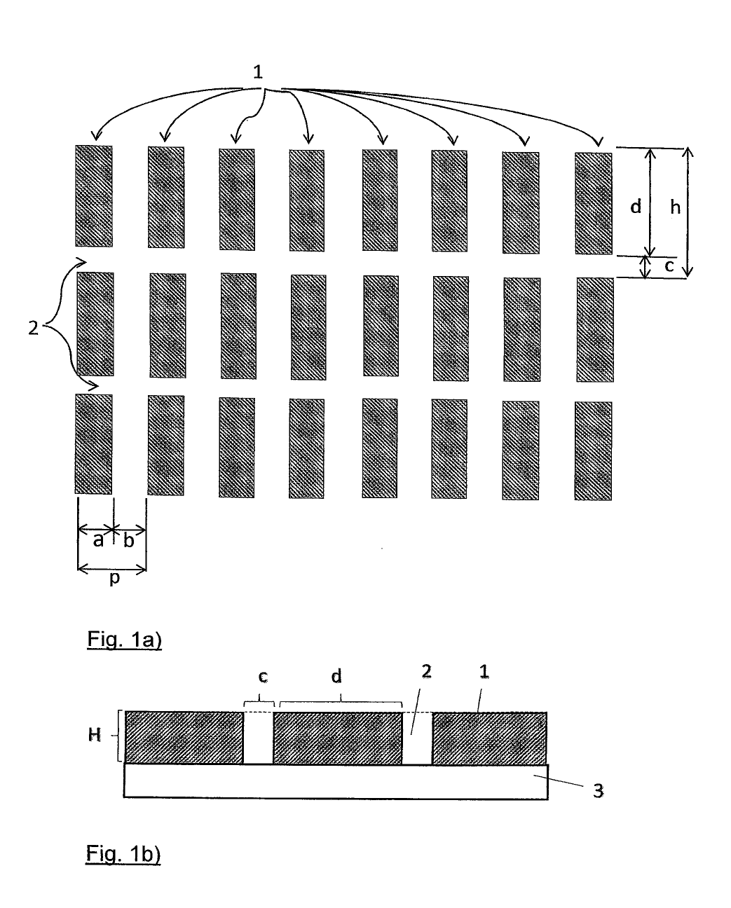

FIG. 1 shows an example of a first configuration of the proposed polarization filter in plan view (partial Figure a) and in cross section (partial Figure b). The polarization filter has a periodic line grid made of parallel extending metal webs 1. In the case of the proposed polarization filter these metallic webs 1 are interrupted in the longitudinal extension by slots 2. This means that reliable production of the polarization filter or the metallic webs of the line grid can be guaranteed, without them tilting or even collapsing during production. The slots 2 are applied between the metallic webs 1 at all points where they are required for mechanical stability. The metallic webs 1 in the present example have a width a, and the intermediate spaces between the metallic webs 1 a width b. This results in a period, or pitch, p of the grid lines or webs of p=a+b. In order to achieve a good effect as a polarization filter, the pitch p of the grid lines in the direction perpendicular to the extension of the grid lines must be less than λₘᵢₙ, where λₘᵢₙ is the lowest wavelength of the wavelength range from λₘᵢₙ to λₘₐₓ for which the polarizing filter is designed. The centre distances of the slots 2 in the direction parallel to the grid lines must be selected to be greater than λₘₐₓ, so that the action of the polarization filter is not degraded by these slots 2. In the example of FIG. 1 the width c of the slots 2 and a distance d between the slots 2 are indicated, which results in a pitch h of these slots in the direction parallel to the grid lines. This pitch h, or centre-to-centre distance between the slots 2, can be constant over the entire polarization filter, or can vary from line to line and can also vary along each web 1.

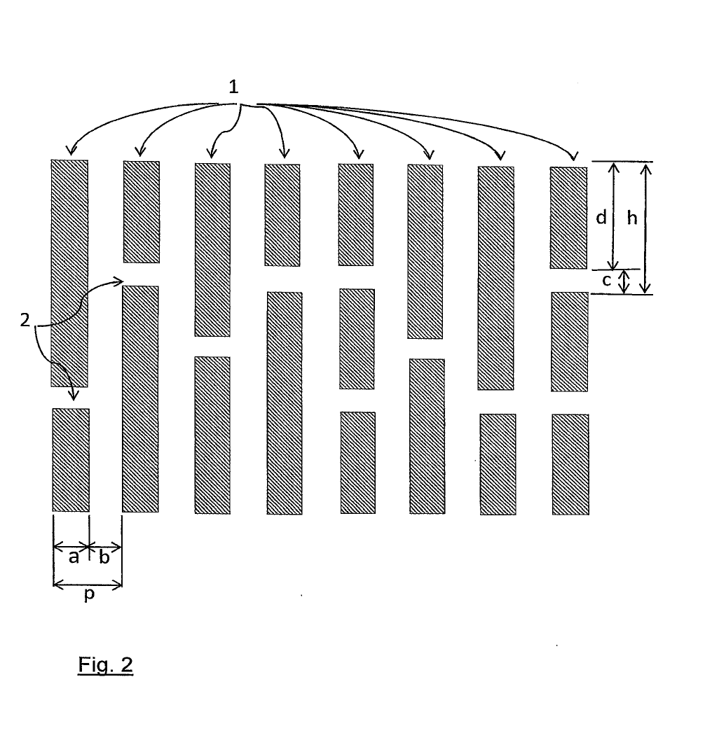

Thus FIG. 2 shows, for example, a configuration of the proposed polarization filter with irregularly spaced slots 2, in which the centre-to-centre distances between the slots 2 vary across the polarization filter. Here again, the pitch h of the slots 2 must be larger than λₘₐₓ in the direction parallel to the lines of the line grid, but it need not be the same everywhere.

In partial Figure b) of FIG. 1, a cross section through the polarization filter of partial Figure a) of FIG. 1 is also shown. In this cross-sectional view, the height H of the metallic webs 1 can be seen, together with in this example the depth of the slots 2 corresponding to the height H. The height H is selected to be greater than the width a of the metallic webs 1 to obtain the best possible contrast of the polarization filter. The width c of the slots 2 can be selected from a large range. The lower limit is determined by the minimum slot width that can still be implemented in the selected CMOS process, e.g. 100 nm or less. The maximum permissible slot width is not limited, but the polarization contrast degrades with increasing slot width. This partial Figure b) also shows the dielectric layer 3 on which the metallic structure is arranged.

A further possibility for implementing the polarization filter consists of an arrangement in which the slots 2 do not extend perpendicular to the metallic grid webs 1, but rather are inclined at a different angle to these webs. An example of such a design is shown in FIG. 4. In turn, the above dimensioning guidelines for the centre-to-centre distance between the slots 2 also apply here.

Each of the basic arrangements suitable for the design of the device as a polarization filter can also be used in such a way that the respective basic arrangement, or the respective line grid with the parallel extending metal webs 1 and the slots 2, is repeated one or more times. This type of arrangement can be used, for example, to completely cover the surface of a photodiode located under the polarization filter with the polarization filter structures. This allows the metallic webs of the grid elements of adjacent line arrays also to be connected to each other.

### LIST OF REFERENCE NUMERALS

1 metallic grid webs
2 slots
3 dielectric layer
a width of the grid webs
b width of the space between the grid webs
c width of the slots
d width of the space between the slots
h centre-to-centre distance between the slots
p centre-to-centre distance or pitch of the metallic grid webs
H height of the metallic grid webs

1. Polarization filter, in particular for the visible or ultraviolet spectral range, which is formed by at least one periodic line grid made from parallel extending metallic webs (1) on a dielectric layer (3),
characterized in that
the metallic webs (1) are interrupted by slots (2) in their longitudinal extension, wherein centre-to-centre distances between the slots (2) in the longitudinal extension of the metallic webs (1) are greater than the period of the line grid.

2. Polarization filter according to claim 1,
characterized in that
the slots (2) extend perpendicular to the metallic webs (1) of the line grid.

3. Polarization filter according to claim 1 or 2,
characterized in that
the centre-to-centre distances between the slots (2) vary across the polarization filter.

4. Polarization filter according to any one of claims 1 to 3,
characterized in that
the metallic webs (1) of the line grid have a height above the dielectric layer (3) which is greater than their width.

5. Polarization filter according to any one of claims 1 to 4,
characterized in that
the slots (2) extend as far as the dielectric layer (3).

6. Polarization filter according to any one of claims 1 to 5,
characterized in that
a plurality of the periodic line grids made from the parallel extending metallic webs (1) with the slots (2) are arranged next to each other.

7. Polarization sensor with a photo-sensitive element, above which a polarization filter according to any one of the previous claims is constructed.
